(19) United States
(12) Patent Application Publication
(10) Pub. No.: US 2018/0207934 A1
(43) Pub. Date: Jul. 26, 2018

(54) INKJET PRINTING METHOD, AND ASSEMBLY FOR CARRYING OUT THE METHOD

(71) Applicant: Forschungszentrum Juelich GmbH, Juelich (SE)

(72) Inventors: Alexey Yakushenko, Aachen (DE); Bernd Bachmann, Bergisch Gladbach (DE); Bernhard Wolfrum, Aachen (DE)

(21) Appl. No.: 15/326,500

(22) PCT Filed: Jun. 11, 2015
(86) PCT No.: PCT/DE2015/000283

§ 371 Date: Jan. 16, 2017

(30) Foreign Application Priority Data
Jul. 17, 2014 (DE) 10 2014 010 643.8

(51) Int. Cl. B41J 2/14

(52) U.S. Cl. CPC B41J 2/14427; B41J 2202/08; B41J 2002/14443

(57) ABSTRACT

An inkjet printing method includes directing a printhead of an inkjet printer towards a substrate to be printed, generating ink drops in the printhead of the inkjet printer, and directing the ink drops, after they have been discharged from the nozzle of the printhead, into a zone with a locally increased temperature in such a way that the volume of the drops is actively reduced during the phase of flight to the substrate.

### CROSS REFERENCE TO RELATED APPLICATIONS

This application is a U.S. National Stage Application under 35 U.S.C. § 371 of International Application No. PCT/DE2015/000283 filed on Jun. 11, 2015, and claims benefit to German Patent Application No. DE 10 2014 010 643.8 filed on Jul. 17, 2014. The International Application was published in German on Jan. 21, 2016 as WO 2016/008464 A1 under PCT Article 21(2).

### FIELD

The invention relates to an inkjet printing method and to an assembly for carrying out an inkjet printing method.

### BACKGROUND

During inkjet printing, individual drops of ink are conventionally generated in a nozzle of the printhead. FIG. 1a shows the prior art in this respect. The drops are either generated by a thermal process using an air bubble (thermal inkjet) or by means of a pressure pulse, which is generated either by a piezo crystal (piezo inkjet) or electrostatically (super-fine inkjet®).

A distinction is made between CIJ (continuous inkjet) printers and DOD (drop on demand) printers. In the case of CIJ printing, the inkjet is discharged out of the printhead via a nozzle. This jet is modulated by a piezoelectric transducer, which is located behind the nozzle, in such a way that an even disintegration into individual drops is achieved. The drops thus formed are now electrostatically charged to a lesser or greater extent by a charging electrode. The drops with a speed of 10 to 40 m/s subsequently fly through a larger deflecting electrode, where—depending on the specific electrical charge thereof—they are deflected laterally. Depending on the type of device, the charged or uncharged drops reach the substrate. Drops which are not required are already caught again on the printhead and fed into the ink circuit once again. In the DOD process, in contrast to CIJ printers, only the ink drops that are actually required leave the nozzle. Additionally, the devices are distinguished by the technology by means of which the ink drops are discharged. a) Bubble jet printers generate tiny ink drops with the aid of a heating element which heats the water or solvent in the ink. In the process, a tiny steam bubble forms explosively, which pushes an ink drop out of the nozzle due to the pressure thereof. b) Piezo printers use the piezoelectric effect to push the printing ink through a fine nozzle, ceramic elements deforming under voltage. The ink forms drops, the volume of which can be controlled by the size of the electrical pulses applied. c) In the case of pressure-valve printers, individual valves are attached to the nozzles and open when a drop is to leave the nozzle. In any case, the drop is discharged from the nozzle, is jetted and lands on a substrate. A plurality of drops that are jetted out and land on the substrate form the printed structure.

The resolution of the printed structure is defined by the size of the individual drops and the gap between individual drops. It is generally the case that the smaller an individual drop, the greater the resolution of the print. Therefore, one aim is to generate smaller drops. Normally, the size of the drop is influenced during the formation thereof in the nozzle. If, for example, nozzles having a small diameter are used in the printhead, then smaller drops are generated than when printing with larger nozzles in the printhead. In the case of a piezo printhead, the applied voltage waveform and the time and the temperature of the printhead and the ink itself play an important role. By modifying the voltage waveform and the temperature, the size of the drop can be reduced significantly as is known from Meier et al., (Phys. Status Solidi A (2009). Inkjet printed, conductive, 25 μm wide silver tracks on unstructured polyimide. Vol. 206, 1626-1630). In addition, the interaction between the drop and the substrate is of great importance. If, for example, a hydrophobic ink is printed, the hydrophilic modification of the substrate can lead to a significant reduction in the drop size on the substrate. This allows a denser placement of the drops, combined with a greater resolution.

It is known from the publication by Perelaer et al. (Macromolecular Chemistry and Physics (2009). Droplet tailoring using evaporative inkjet printing. Vol. 210, 387-393) that, as a result of a greater gap between the printhead (more specifically the nozzles) and the substrate, a partial evaporation of the ink solvent occurs, as a result of which the drops become correspondingly smaller. In this case, the method takes into consideration the composition of the ink as well as the gap. Disadvantageously, as a result of the greater gap, a dispersion of individual drops is generated, as a result of which errors occur in the placement of individual drops. This reduces the resolution of the printed structure.

A device is known from the published application WO 2013/166219 A1, which allows an in-flight drying of ink drops. For this purpose, an environment of zones having different temperatures is generated between the printhead and the substrate to be printed. The device comprises a large number of structures, such as spacers, which separate a thermal shield from the printhead, further spacers, which separate the thermal shield from a condensation shield, and energy sources on the condensation shield. The temperature at the printhead should be low, and between the heat shield and the condensation shield and between the condensation shield and the substrate, it should be high so that vapors rising from the substrate do not reach the printhead. During the process, the condensation shield is heated to a temperature above the condensation temperature of the carrier liquid of the ink in order to prevent the condensation of the vapors. This assembly is disadvantageously complex in structure.

A printhead for an inkjet printer is known from the published application WO 2010/134072 A1, which printhead is provided with a thermal shield towards the substrate in order to prevent the transfer of heat between a heated substrate and the printhead. This assembly also serves to provide corrosion protection for the printhead in that rising vapors and heat are kept away therefrom.

### SUMMARY

In an embodiment, the present invention provides an inkjet printing method, comprising: directing a printhead of an inkjet printer towards a substrate to be printed; generating ink drops in the printhead of the inkjet printer and discharging the ink drops from a nozzle of the printhead; and then directing the ink drops into a zone with a locally increased temperature so as to actively reduce a volume of the ink drops during a phase of flight to the substrate.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIGS. 1A-1E show a schematic reproduction of a method and the assembly according to an embodiment of the invention (B-E) as well as the prior art (A);

FIGS. 2A and 2B show a schematic reproduction of a method and the assembly according to an embodiment of the invention; and

FIG. 3 shows a zone with a locally increased temperature and temperature profile according to an embodiment of the invention.

### DETAILED DESCRIPTION

A method and an assembly are described herein by way of which a significant reduction in drop volume and therefore a higher resolution inkjet printing can be achieved.

In an inkjet printing method according to an embodiment of the invention, a printhead of an inkjet printer is directed towards a substrate to be printed. Ink drops are generated in the printhead of the inkjet printer. After being discharged from the nozzle of the printhead, the drops are directed into a zone with a locally increased temperature in such a way that the volume of the drops is actively reduced during the phase of flight to the substrate.

The method and the assembly according to an embodiment of the invention allow the reduction of individual drops “in-flight” during the inkjet printing process. The reduction occurs by means of the local, rapid heating of the drop and the thus increased evaporation rate, which causes a significant reduction in drop volume in a short time. The heating is achieved by the local supply of energy to the drop. The energy can, for example, be supplied by the interaction of the drop with light or with at least one filament.

According to an embodiment of the invention, the light and the filament or filaments generate a zone with a locally increased temperature in the jet path of an inkjet printer. According to an embodiment of the invention, following the discharge of the drops from the nozzle of the printhead, said drops initially pass through a first cold zone, then the zone with a locally increased temperature and subsequently, a second cold zone before they hit the substrate. According to an embodiment of the invention, the printhead and the substrate are not influenced by the zone with a locally increased temperature. Therefore, according to an embodiment of the invention, by way of the method and by way of the assembly and the zone with a locally increased temperature which is generated thereby, a locally limited energy supply to the drop occurs. This leads to an active reduction of the volume of the drop and therefore to an improvement of the resolution in the printing process.

An ink drop can, for example, be directed through a small conductive mesh comprising at least one or more filaments, through which mesh the current is conducted and consequently a local increase in temperature is generated. Therefore, one or more filaments can be used, which generate the zone with a locally increased temperature. The filament or filaments is/are, of course, not touched by the drops passing through.

Alternatively, or in combination with the mesh, light can also be beamed at an appropriate wavelength onto the drop after the drop has been jetted out of the nozzle of the printhead. As a result of the absorption of the optical or thermal energy by the ink components of the drop, the liquid inside the drop is heated up and part or most of said liquid vaporizes. The evaporation is actively increased as a result. This leads to the desired reduction in volume of the drop by comparison with the volume of the drop when it leaves the printhead nozzle. Other properties of the drop such as the shape, speed, viscosity, surface tension and/or density thereof can also be modified in a targeted manner by the active vaporization.

An objective of the energy supply, such as is achieved by optical or thermal processes, is the reduction in volume, and therefore as a result, a smaller ink drop as print (pixel) on the substrate. This allows the desired higher resolution of the structures generated by the inkjet printing method according to the invention.

A significant reduction in drop volume by at least 10%, 11, 12, 13, 14, 15, 16, 17, 18, or 19% is advantageously brought about by the inkjet printing method according to the invention. A drop with, for example, 1 pL volume then has a volume of about 900 fL at most after the passage through the zone with a locally increased temperature.

Most advantageously, by means of the inkjet printing method according to an embodiment of the invention, a reduction in the volume of the drop by at least 20%, more preferably by at least 21, 22, 23, 24, 25, 26, 27, 28, 29, 30%, further preferably by at least 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 49, 80, 81, 82, 83, 84, 85, 86, 87, 88, 89 or even 99% or any chosen value in between is brought about.

As a result, by means of the proposed inkjet printing method, an increase in the resolution by at least 1, 2, 3, 4, 5, 6, 7, 8, 9 or even at least 10%, more preferably by at least 11, 12, 13, 14, 15, 16, 17, 18, 19, 20, 21, 22, 23, 24, 25, 26, 27, 28, 29, 30%, further preferably by at least 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 49, 80, 81, 82, 83, 84, 85, 86, 87, 88, 89, 90, 91, 92, 93, 94, 95, 96, 97, 98, 99, 99.1, 99.2, 99.3, 99.4, 99.5, 99.6, 99.7, 99.8, 99.9 or even 99.99%, or any chosen value in between is advantageously brought about.

In one embodiment of the invention, a light source having a certain wavelength, beam properties such as diameter, shape, power, pulsed or continuous, is used. The light source is placed in such a way that the light beam shines locally between the printhead (thermal, piezo-based printhead or super-fine inkjet® and Aerosol Jet® printhead) of an inkjet printer and the substrate. For this purpose, the light source can advantageously be placed directly next to the printhead, or the light can be directed by a beam conductor, such as an optical fiber or via deflection mirrors to the printhead. These printheads can, of course, also be used with the mesh comprising a filament or filaments according to an embodiment of the invention as an attachment.

Alternatively, a printhead can be set up in which the light source and/or the light conductor are integrated into the printhead in such a way that the light shines locally into the space between the printhead and the substrate. The light source can generate only one beam or a plurality of beams, for example by splitting the beam of a light source into a plurality by means of optical fibers or by using two or more light sources having the same or different optical properties. As a result, it is advantageously brought about that drops from a plurality of nozzles at the same time or the drops from one nozzle having different colors are to be shone onto.

A light source as the first alternative should generate a big enough beam that the drop that is discharged from the nozzle has a sufficient contact surface with the light beam and consequently a sufficient contact time with the light beam. The beam has no contact with the printhead or the substrate so that the print properties of the ink are not influenced before the flight phase and no interaction with the printed structures occurs either.

More advantageously, collimated light of a coherent light source is used. As a result, it is advantageously brought about that the diameter of the light beam can be kept constant over longer distances and does not diverge. If longer interaction times between the drop and the beam are required, a diverging light source can alternatively be used, which illuminates a larger surface, and therefore the length of time for which the drop is located in the illuminated region increases. As a result, a further reduction in volume of the drop is advantageously brought about. A blocking of the beam conducted through the drop can be achieved, for example, by fixing a beam trap to the side of the printhead which is present opposite the light source exit.

The light source can be a laser, which operates in a pulsed continuous manner. An LED or a different light-generating system can likewise be used. The light source or plurality of light sources should be selected in such a way that the wavelength(s) thereof is/are absorbed well by the solvent or plurality of solvents in the printing ink or by the contents dissolved in the solvent.

The interaction time between the drop and the light or the filament or filaments becomes very short because the speed of the drop is generally relatively high. Normally, the speed of the drop is in the range between 100 m/s and 0.01 m/s. This means that the flight times of the drop through the light beam or past the filaments respectively, i.e. the interaction times, are between 1 ns to 10 ms and in this case, are dependent on the size of drop and the width of the beam and the temperature. Therefore, the light source and the filament or filaments should have enough power to actively evaporate enough solvent of the ink in the short interaction times of from 1 ns to 10 ms, but on the other hand, not be too high either, and in particular not influence the temperature of the printhead or of the substrate.

The light source and the filaments can, but do not have to, interact with the functional material of the ink. The light source and the filament or filaments can bring about an “in-flight sintering” of metal nanoparticles or an “in-flight cross-linking” of a polymer in the ink.

Different systems for generating a zone with a locally increased temperature can be used for different inks. For water-based inks, for example, light sources with beams which are close to infrared are particularly suitable, since water absorbs particularly well at this wavelength. The zone with a locally increased temperature is generated between the substrate and the printhead. The ink drops pass through this zone after leaving the nozzle of the printhead and before landing on the substrate. The drops are locally heated by means of a light beam and/or by a filament or filaments, and the solvents in the drops are actively at least partially or fully vaporized or evaporated in this manner. This always leads as a result to a reduction in the volume of the drop or also to a modification of other properties of the drop such as the shape, speed, viscosity, surface tension or density thereof. The resulting, smaller drops are printed onto the substrate.

According to an embodiment of the invention, the method advantageously also allows a denser positioning of individual drops relative to one another and accordingly thus allows a higher resolution and smaller minimum structures.

A light beam as the first alternative for generating a zone with a locally increased temperature should advantageously have an adjustable power so that the evaporation rate and therefore the resulting drop size can be regulated. If, alternatively, one or more filaments are used, then current from an adjustable power or voltage source should also be applied thereto.

A light source should also have a switch, so that light can be switched on and off as required. According to the invention, the light beam should also have a mechanism that can adjust the position of the beam in the X, Y and Z directions. This can become necessary in order to be able to hit the beam with the drops better.

As an alternative to or in combination with one or more light sources for the local heating of the drops, a conductive mesh, preferably made from metal or another conductive material, is more advantageously used. The mesh has openings, which are large enough to allow individual drops to pass through the intermediate spaces between the filaments. A mesh can also comprise only one filament. Then the drop passes within close proximity of the filament and the zone generated thereby with a locally increased temperature.

The conductive mesh preferably comprises two electrically conductive plates, for example made of an electrically conductive metal, which are both electrically insulated from one another, and are arranged on a substrate. The substrate acts as a heat shield. The at least one filament is stretched between the two plates and connects the two plates to one another. In this case, the electrical resistance in the filament or filaments is greater than that in the supplying plates by at least one order of magnitude, i.e. 10 times greater, preferably 20 times greater, 30, 40, 50, 60, 70, 80, 90 or 100 times greater, or even up to 1,000 times greater, or preferably even up to 10,000 times greater, or any chosen value in between. As a result, it is advantageously brought about that just the filament or filaments and not the plates themselves are heated by the energy supply. As a result, the zone with a locally increased temperature is generated in the immediate environment of the filament or filaments but not in the plates. The higher the resistance ratio between the filament or filaments and the plates, the better. The ratio is influenced significantly by the materials and the geometry of the plates and the filament or filaments.

If an adequate current is conducted through this mesh and the filaments thereof, then the filament or filaments are heated up and as a result, generate a local temperature increase in the direct vicinity of the filament or filaments thereof. When the drops fly along the filament or filaments without touching it/them, they are heated up by the increased temperature present there and, in this manner, the evaporation rate of the solvent of the ink is preferably actively increased. As a result of this active vaporization, the volume of the drop becomes smaller.

So much energy is supplied that the temperature of the drop when passing through the zones with locally increased temperatures should not exceed the boiling point of the drop and the components thereof. The temperature of the filament or filaments and in the light beam must be high enough to vaporize enough solvent of the ink in these short interaction and flight times of just 1 ns to 10 ms. Having said that, it must not be too high and also must not influence the temperature of the printhead and of the substrate.

In this sense, the assembly can have an attachment with at least one or more filaments for thermal vaporization of preferably the solvent of the ink. The drops from the printhead are heated by the local temperature gradients and vaporized. The local temperature gradient is generated by heating up a mesh or by heating up for example two filaments extending in parallel with one another, or alternatively or in combination with one or more light sources.

In this sense, the assembly can also have an attachment comprising at least one or more light sources for thermal vaporization of preferably the solvent of the ink. The drops from the printhead are heated up by the local temperature gradient and vaporized. The local temperature gradient is generated by heating up the ink in the light beam of a light source or alternatively or in combination with one or more filaments. An attachment according to an embodiment of the invention for an existing printhead is provided for this purpose. The attachment for generating the local temperature gradient can be in two parts. A first part is fixed and is attached to or on the printhead or the printhead holder. The other part is attached rigidly or reversibly on the first part, for example by bonding or by a magnetic mechanism.

An attachment according to an embodiment of the invention for a printhead of an inkjet printer preferably comprises:
a heat shield directed towards the substrate with an opening for the ink,
two electrically conductive plates arranged directly on the heat shield, directed towards the substrate and provided with electrical supply lines, which, viewed in isolation, are electrically separated from one another by an intermediate space,
the intermediate space between the plates being arranged underneath the opening of the heat shield, and
at least one filament, which connects the two plates to one another,
the electrical supply lines conducting current via the plates into the at least one filament to generate a zone with a locally increased temperature.

In this case, the electrical resistance in the filament or filaments during operation can be greater than that in the supplying plates by at least one order of magnitude, i.e. 10 times, preferably 20 times, 30 times, 40 times, 50 times, 60 times, 70 times, 80 times, 90 times or 100 times greater, or even up to 1,000 times greater, or preferably even up to 10,000 times greater, or any chosen value in between. As a result of this, it is brought about that the zone with a locally increased temperature is generated only on the filament and not on the plates.

The attachment according to an embodiment of the invention for a printhead holder thus comprises a heat shield in particular. The heat shield is made from an electrically and thermally insulating material such as anodized aluminum. The heat shield has a small opening for the ink drops. The heat shield protects the printhead advantageously from increased temperatures.

Two thin, electrically conductive plates are arranged on the heat shield, directly on the heat shield, i.e. without any further spacers to the heat shield. The plates are electrical conductors, i.e. thin metal plates or foils made of steel. The two plates can be bonded to the heat shield or otherwise arranged directly on the heat shield. The two plates on the heat shield, viewed in isolation, are electrically insulated from one another. This means that the two plates have an intermediate space therebetween, in such a way that they have no physical contact with one another. This space is arranged directly opposite the opening in the heat shield, in such a way that the drops leaving the nozzle pass through the attachment towards the substrate without touching the heat shield, the plates or the filaments stretched therebetween.

Other materials can, of course, be used for the heat shield and/or the plates. Materials considered for the heat shield are for example, but not exclusively, glass, quartz and ceramics. These materials are advantageously easy to process and inexpensive. The opening in the heat shield can be for example 0.5 mm wide.

In addition to the above-mentioned steel, materials considered for the plates are for example, but not exclusively, also carbon and copper as well as for example indium titanium oxide (ITO). A person skilled in the art can freely combine these materials in order to produce the attachment according to the invention for the printhead. For example, glass with an opening of 0.5 mm can be used as a heat shield. Steel plates having a thickness of 0.5 mm are bonded directly onto said glass. The filament is bonded as described to the plates with conductive silver adhesive in between and baked. For example, glass with an opening of 0.5 mm can be used as a heat shield. Carbon plates having a thickness of for example 0.1 mm are bonded directly onto said glass. The filament is bonded to the carbon plates with conductive carbon paste. For example, a ceramic with an opening of 0.5 mm can be used as a heat shield. Copper plates having a thickness of for example 0.1 mm are bonded directly onto said ceramic. The filament is bonded to the carbon plates with conductive silver adhesive.

Glass or quartz can also be processed using the method of optical lithography. The glass or quartz is used as a heat shield and has an opening of 0.5 mm. Two ITO plates (indium tin oxide) are deposited onto said glass or quartz with a thickness of 1 μm and are structured with optical lithography. Between the plates, the filament or a mesh made from tungsten with a width of 10 μm is deposited on the glass or quartz and between the ITO plates and is structured with optical lithography in such a way that the two ITO plates are bridged by the tungsten wires.

A person skilled in the art can apply further depositing methods from optical lithography in order to produce an attachment according to an embodiment of the invention.

At least one thin filament is arranged accordingly as a connection between the two plates. The attachment then comprises the heat shield, the plates arranged thereon and the filament arranged therebetween, as well as electrical supply lines to the two conductive plates in such a way that they can be connected to a current source or a voltage source, which heats up the filament.

There is no additional gap between the heat shield and the conductive plates. The attachment comprising heat shield and plates is therefore advantageously very thin and, for reasons of space, can readily be arranged between a nozzle of a printhead and the substrate. The assembly of heat shield and electrically conductive plates with filaments is preferably between 0.5 to 5 mm thick overall. The fastening of the attachment to the printhead also does not use up any additional space in the beam direction of the ink. This also ensures that the assembly can be fastened easily between a printhead and the substrate.

The attachment according to an embodiment of the invention is fastened to the printhead for example by bonding, clamping devices or slots introduced into the printhead, into which the assembly of heat shield and plates can be pushed. The type of the fastening, which is within the scope of the expert knowledge of a person skilled in the art, should, of course, also be able to be achieved in other ways, for example by one or more magnets which can be sunk into the material of the printhead, provided that the attachment comprises magnetic material such as the above-mentioned steel plates. The attachment can also be screwed on or otherwise fastened to the printhead. The type of the fastening should not have any influence on the thickness of the attachment. After fastening, the filaments are arranged very close to the substrate.

A second attachment according to an embodiment of the invention for a printhead of an inkjet printer thus comprises:
a heat shield directed towards the substrate with an opening for the ink,
at least one light source, which beams into the jet path below the opening of the heat shield and creates a zone with a locally increased temperature for the ink drops.
   This attachment is also correspondingly very thin. An attachment according to the invention should be fastened to the printhead in such a way that it can be finely adjusted. The adjustment is carried out in the plane in such a way that the drops pass through the light beam or fly along the filament or filaments and have to pass through the zone with a locally increased temperature. Any printheads can be modified with the attachments according to an embodiment of the invention, in particular those of industrial printers.

Such an attachment according to an embodiment of the invention can be arranged in an assembly according to an embodiment of the invention comprising a printhead with a nozzle, for example in that small magnets are provided and arranged so as to be sunk into the printhead, which magnets attract and retain the metal plates of the attachment according to the invention through the heat shield. Other types of fastening are also possible. In this case, it should be noted that the available space in the jet path is normally limited. The fastening means must be adapted to this, i.e. they should not take up any additional space towards the ink jet.

The type of the fastening is such that the attachment according to an embodiment of the invention is advantageously also still aligned in the plane following the fastening thereof to the printhead in such a way that the drops are jetted directly along the filament or filaments through onto the substrate without touching them and fly through the light beam. To align the attachment, adjusting screws can be used. The attachment is fastened in such a way that the thickness of the attachment is advantageously not increased by the fastening means, as the available space between the substrate and a printhead is normally very limited. The attachment can accordingly also consist of a heat shield and light sources arranged thereon, which light sources beam into the space between the printhead and substrate and generate the zone with a locally increased temperature.

A drop from the nozzle of a printhead must fly through the attachment towards the substrate. For this purpose, after being discharged from the nozzle, said drop will initially pass through the opening in the heat shield and directly afterwards, fly past the filament or filaments or pass through the light beam without having to pass through another intermediate space between the heat shield and the two plates for this purpose.

This attachment comprising a heat shield and preferably metal plates with a filament or filaments, or a light source is advantageously very thin overall, for example having a thickness of only 0.5, 0.6, 0.7, 0.8, 0.9 or 1 mm, or 2, 3, 4, 5, 6, 7, 8, 9 or 10 mm or a value in between. This advantageously brings about the generation of a zone with a locally increased temperature between the printhead and substrate such that in the jet path of the printer, a cold zone on the printhead, and then the zone with a locally increased temperature and a second cold zone on the substrate are generated.

The jet path in the printhead then consists of the printhead with a nozzle, the attachment according to the invention for the printhead and the substrate to be printed. In the print direction and flight direction, the attachment has the heat shield to protect the printhead and the nozzle as well as the ink. In one alternative, the two plates, preferably metal plates, which bear the filament or filaments and/or alternatively the means for generating the light, are arranged below the heat shield. Congruent openings are arranged in the heat shield and optionally the plates of the attachment, for the passage of the drops flying therethrough onto the substrate. In the alternative with just one or more filaments, the jet path of the printer has the printhead with the nozzle as well as preferably a heat shield with an opening, as well as the plates with the heatable filament or filaments arranged thereon towards the substrate, which generate the zone with a locally increased temperature.

The two metal plates are accordingly interconnected by one or more thin wires, i.e. with a diameter which is for example 1 μm, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101 . . . , 398, 399 or 400 μm thick or with any other chosen value in between made of metal conductors such as gold, tungsten, copper, aluminum, carbon, constantan, manganin, chrome, titanium or other metal compounds. The plates are electrically insulated from one another excluding the filament or filaments.

The applied current flows through the wire or wires. For example, the current can have a current strength of 1 μA, 1 mA to 150 A or any other chosen value in between, provided it only generates the temperature gradient. The current generates the joule heating of the filament or filaments. According to the invention, the electrical resistance of the wire or wires compared with the two (metal) plates is greater, as a result of which the wires are heated much more by the current than the (metal) plates themselves. In this manner, the local generation of the temperature profile is generated and moreover, the printhead and the substrate are advantageously protected from the temperature.

Therefore, a temperature gradient with respect to the rest of the space around the printhead is only generated on and between the wires or through the light source. The temperature gradient between two wires depends on the gap between the wires. The gap between the wires is preferably set in such a way that the gradient is at its steepest and that the drops can fly between the wires without touching the wires. The gap is set, for example, at between 10 μm and 1 mm and preferably at between 50 μm to 100 μm. The temperature gradient or a high temperature field is used for the through-flight of generated drops. In the process, the drops jetted out of the nozzle of the printhead are accelerated through the wires on the path towards the substrate. During the through-flight, the drops are heated up and the solvents of the ink are partially or fully vaporized. As a result of this vaporization, the size of the drops after the through-flight thereof is drastically reduced in comparison with the size before the through-flight. This makes it possible to place smaller drops on the substrate and therefore to achieve a higher resolution in the inkjet printing process.

In both alternatives, i.e. use of one or more light sources or of one or more filaments, a vent can most advantageously be provided and used around the printhead to take solvent vapors away. This vent can be provided and used for example as an attachment for the printhead. For this purpose, small vent pipes made of metal or plastics material or another material which is inert for the ink solvents are constructed along both sides of the printhead. In this manner, the selected material can achieve good corrosion protection against the solvent for the attachment. These small pipes are connected to a pump, a vent or other means for generating negative pressure by means of tubes. The airflow arising as a result of the negative pressure should be strong enough to remove the vaporized solvent out of the print region, but not so strong that the flight path of the jetted drop would be influenced. The vent thus serves only to remove vaporized solvent from the print region and to prevent the subsequent drops and the physical properties thereof from being influenced. The vent can either be integrated into an existing printhead or it can be used as part of the design for a new printhead. Alternatively, the whole printer can be located in a protected atmosphere with vapors suctioned off.

In the zone with a locally increased temperature, a temperature is generated in the drop which is below the boiling point of the solvent or the solvent compound of the ink. Otherwise it would no longer be possible to control the printed image on the substrate because the drops would otherwise burst.

A person skilled in the art will increase the temperature in the zone with a locally increased temperature depending on the components and, in particular, the solvent of the ink used, by means of the filament and/or light source in such a way that the desired print image is generated and at the same time, the resolution is increased significantly in comparison with a standard inkjet printing method without active reduction of the volume by increasing the temperature of the ink drops.

For the method according to an embodiment of the invention, an ink can advantageously be used which has a solvent that absorbs light or temperature particularly strongly and consequently, the evaporation and reduction of the drop in flight progresses with less energy in a shorter time. One or all solvents of the ink should then have a strong absorption in the wavelength of the light used.

The heating mechanism that is used must not heat the printhead itself and should not modify the physical properties of the ink either or influence the jetting behavior of the ink out of the nozzles. To this end, it can advantageously be provided for a heat shield to be arranged between the printhead and the zone with a locally increased temperature.

For the inkjet printing method according to the invention, the printhead should advantageously be protected from the zone with a locally increased temperature by a heat shield. As a result, it is most advantageously brought about that the physical properties of the ink do not already change as a result of increased temperature input before leaving the nozzle. Furthermore, as a result of this, a blockage of the nozzle of the printhead is also prevented in a particularly appropriate manner.

The assembly according to an embodiment of the invention has an inkjet printhead with a nozzle. Moreover, the assembly has at least one filament or metal mesh, which is to have electric current applied thereto, or alternatively or in combination therewith, a light source for generating a beam between the nozzle of the inkjet printhead and a substrate to be printed. The filament or filaments, or the light source are used for generating a zone with a locally increased temperature and local heating of the ink being discharged from the printhead nozzle, as a result of which the volume of the drop, which passes through the zone on the path towards the substrate, is actively reduced. For this version, the two ends of a filament can be provided so as to be fastened to two metal conductors, for example as a metal mesh.

Most advantageously, the two electrical conductors, for example the metal plates, with which electric current can be conducted into the filaments, are arranged directly on a heat shield directed towards the printhead. This means that there are no spacers between the metal plates and the heat shield.

Irrespective of the kind of assembly and attachment according to an embodiment of the invention, i.e. with at least one or more filaments or with at least one light source, a zone of an increased temperature is most advantageously generated with a temperature profile between the printhead and the substrate.

The attachment according to an embodiment of the invention and the assembly according to the invention with a filament or light source generates the zone with a locally increased temperature. In the zone, a temperature profile is generated in such a way that on a path length of about 1 mm, a temperature difference has a value of at least 10, 11, 12, 13, 14, 15, 16, 17, 18, 19, 20, 21, 22, 23, 24, 25, 26, 27, 28, 29, 30° C., more preferably of at least 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 49, 80, 81, 82, 83, 84, 85, 86, 87, 88, 89 or even 90° C., likewise preferably at least 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, 125, 126, 127, 128, 129, 130, 131, 132, 133, 134, 135, 136, 137, 138, 139, 140, 141, 142, 143, 144, 145, 146, 147, 148, 149, 150, 151, 152, 153, 154, 155, 156, 157, 158, 159, 160, 161, 162, 163, 164, 165, 166, 167, 168, 169, 170, 171, 172, 173, 174, 175, 176, 177, 178, 179, 180, 181, 182, 183, 184, 185, 186, 187, 188, 189, 190, 191, 192, 193, 194, 195, 196, 197, 198, 199, or 200° C. or any chosen value in between.

The temperature gradient in the zone with a locally increased temperature generated by the assembly and attachment according to the invention has regions of different temperatures. These are between about 25° C. in the edge region of the zone and 225° C. directly on the filament or filaments, or in the spot of the light source.

On a free path length along they axis of the print jet, i.e. in the jet path of the printer, of 0 mm, at which the filament or filaments or the light source are positioned, up to about 0.5 mm, temperature differences of up to 150° C. are generated. On a path length along the y axis of between 0 mm and 1 mm, temperature differences of optionally up to about 200° C. are generated.

The temperature profile generated during the method according to an embodiment of the invention is most advantageous as a result of a heat shield of an asymmetrical nature, which means that the printhead is located in the cool, whereas the drop passes through the hot zone before it falls onto the cool substrate.

The following ink can, for example but not exclusively, be used during the inkjet printing method according to an embodiment of the invention. The ink can preferably consist of at least two solvents which have different boiling points and vapor pressures and optionally also different viscosities and surface tensions. The ink can preferably consist of at least one active material, i.e. it should then comprise a polymer, metal nanoparticles, carbon nanoparticles or similar. The ink can, but does not have to, contain additional components such as surfactants, adhesives, or anti-foaming agents. As a result of the heating in flight, a first solvent with the lower boiling point and vapor pressure vaporizes much more vigorously than a further one. In this manner, it is brought about that when printing on the substrate, the drop substantially consists of the solvent with the higher boiling point and lower vapor pressure. When the remaining solvent has a higher viscosity, then the total viscosity of the drop is higher than previously. This consequently means that the drop on the substrate will run less and remain smaller than is the case with a drop with lower viscosity. When the solvent remaining in the drop has a higher surface tension, then the total surface tension of the drop is higher. This consequently means that the drop forms a large angle of contact with the substrate and overall, wets a smaller spot on the substrate than a drop with lower surface tension. However, according to the invention, the surface tension should not exceed 40-50 mN/m in order to prevent the re-accumulation of the drop on the substrate and a smearing of the printed structures. The concentration of active materials such as polymers, metal nanoparticles, carbon nanoparticles, or other materials may be kept low in comparison with an inkjet printing method according to the prior art. As a result of the vaporization of solvent in flight, the proportion by weight of the active material in the drop will rise. This allows the addition of a lower proportion of active material in the ink production. Additionally, a smaller concentration of the active material allows a lower thickness of the printed structures and layers on the substrate in comparison with the inks with a higher concentration of active material. As a result of a greater concentration of the active material in the drop, what is known as the coffee ring or coffee stain effect is reduced. If the viscosity of the solvent with the higher boiling temperature is also higher, this will also promote a still further reduction of the coffee ring or coffee stain effect.

The following composition of the ink can be used. The ink has thiol-stabilized gold nanoparticles with a diameter of 2 to 10 nm. The gold particles have a proportion by weight of 2 wt. % in the ink; the ink has 90% v/v toluene, i.e. a 90% proportion by volume. 10% v/v is a-terpineol (10% proportion by volume).

Due to the high density, the volume of gold nanoparticles in the drop can be ignored. A volume of 1 pL of the drop of this ink will therefore consist almost entirely of solvent in terms of proportion by volume. 98% of the weight of the drop consists of the solvent and only 2% of gold nanoparticles.

Vₜₒₗᵤₑₙₑ=0.90 pL; Vₐ₋ₜₑᵣₚᵢₙₑₒₗ=0.10 pL;

mₜₒₗᵤₑₙₑ=Vₜₒₗᵤₑₙₑ*ρₜₒₗᵤₑₙₑ=0.90 pL*870 g/L=783 pg

mₐ₋ₜₑᵣₚᵢₙₑₒₗ=Vₐ₋ₜₑᵣₚᵢₙₑₒₗ*ρₐ₋ₜₑᵣₚᵢₙₑₒₗ=0.10 pL*930 g/L=93 pg

m_{gold nanoparticles}=18 pg

m_{drop}=783+93+18=894 pg

Such an ink can lose up to 90% of the solvent as a result of the heating in the flight after leaving the nozzle and passing through the zone with a locally increased temperature. This means that the drop volume can be reduced from 1 pL to 100 fL. Due to the difference in boiling point between toluene (boiling point=111° C.) and a-terpineol (boiling point=218° C.) and as a result of the higher vapor pressure, mainly the toluene is vaporized. This means that the mass of the printed drop will only consist of the mass of the a-terpineol and the gold nanoparticles.

m_{drop}=93+18=111 pg

The new concentration of the gold nanoparticles generated in the drop then amounts to:

C_{gold nanoparticles}=18/111*100%=16.2 wt. %.

The diameter of the drop falls, assuming a spherical drop shape, as a result of the vaporization of about 90% of the solvent from 6.2 μm (1 pL drop) to 2.9 μm (100 fL drop).

Thanks to the high viscosity and surface tension of a-terpineol, the drop with a reduced size will also run less and therefore print much smaller onto the substrate, which ultimately achieves the greater resolution when printing. As a result of this, an increase in resolution by more than a factor of 2 is achieved in the present case.

This or other inks can readily be used during the inkjet printing method.

The vent or vapor trap respectively described in the drawings for suctioning off the solvent vapors that occur is produced for example from aluminum and is arranged as part of the overall attachment around the printhead. For this purpose, simple magnetic pads can be used. Essentially, the vent or vapor trap respectively is produced as a slot on two or all four sides along the printhead in the aluminum housing. This slot is connected to a high channel in the attachment and directed outwards through a tube. At the end of the tube, a fan or small vacuum pump can be arranged, which generates the negative pressure and as a result, brings the flow of solvent vapor forming underneath the printhead to the outside. This flow is not too high so as not to deflect the jetted drops from a straight flight path. It should, however, be strong enough to suction the solvent vapors off to the outside. The vent is optional when printing frequency is low, i.e. it is not absolutely necessary when the total volumes of solvent vapors are very small, since the drops are passively directed to the outside and therefore away from the printhead by means of diffusion and convection in the air. Said vent is, however, referred to partially for the present embodiments.

Printheads from Dimatix™ (Fujifilm) are used as the printhead for the embodiments, for example a DMC and a DMCLCP 1 and 10 pL. The printheads are mounted in an OJ300 inkjet printer from the company UniJet. Anodized aluminum is used as the material for the attachment, for the beam traps and for the vapor traps.

### FIRST EMBODIMENT

A first embodiment relates to a pulsed infrared laser with a wavelength of 780-5000 nm, at a pulse duration of 1 μs-1 fs and with a power of 1 mW to 10 W. This is mounted on the printhead as described and as a light source, generates the zone with a locally increased temperature.

### SECOND EMBODIMENT

A second embodiment relates to a further attachment, which is equipped with two filaments for thermal vaporization of the solvents of the ink. The drops from the printhead are heated up through a local temperature gradient and vaporized. The local temperature gradient is generated by heating up a mesh or by heating up two filaments extending in parallel with one another. The attachment for the generation of the local temperature gradient is in two parts. One part is fixed and is fastened to the printhead or to the printhead holder. The other part is fastened to the first part but can also be removed. The second part consists of two extensive metal plates which are electrically insulated from one another. The two metal plates are electrically interconnected by thin wires, i.e. having a diameter which is, for example, 1 μm, 12.5 μm, 25 μm, 50 μm to 200 μm thick or a value in between, made of gold, tungsten, copper, aluminum, carbon, constantan, manganin, chrome, titanium or other metal compounds. The current flows through these two wires. For example, the current can have a current strength of 1 μA, 1 mA to 100 A. The current generates the joule heating of the filaments. Because the wires have a much higher resistance in comparison with the two metal plates, they are heated up much more than the metal plates themselves. In this manner, the local generation of the temperature profile is generated.

Therefore, a temperature gradient in relation to the remaining space around the printhead is generated between the wires. The temperature gradient between two wires depends on the gap between the two wires. The gap between the wires is set such that the gradient is at its greatest and that the drops can fly through the wires without touching the wires. The gap is set at between 10 μm and 1 mm, preferably between 50 μm or 100 μm. The temperature gradient or a high temperature field is used for the through-flight of generated drops. In the process, the drops jetted out of the nozzle of the printhead are accelerated through the wires on the path towards the substrate. During the through-flight, the drops are heated up, and the solvents of the ink are partially or fully vaporized. As a result of this vaporization, the size of the drops is drastically reduced after the through-flight thereof in comparison with the size before the through-flight. This makes it possible to place smaller drops on the substrate and as a result, achieve a higher resolution in the inkjet printing process.

### THIRD EMBODIMENT

According to the third embodiment, the drops are generated from the ink in the printhead by a piezo element and reach the substrate without barriers after a flight phase. An attachment for the “in-flight” vaporization of drops with light energy is mounted on the printhead. It comprises the light source which shines onto the generated drops after the discharge thereof from the nozzle by means of a thin beam from the light source. As a result of the local heating, the solvent of the drop is partially vaporized. After the interaction with the beam, the smaller drop lands on the substrate.

A beam trap is arranged opposite the light source for the light in the attachment. The beam trap blocks the light and suppresses undesirable dispersion. In this case, the beam trap consists of anodized aluminum. Furthermore, the attachment also has a vapor trap for suctioning off solvent vapors. A thin beam from the light source shines on the generated drops. As a result of the local heating in the beam, the solvent of the drop is partially vaporized. The solvent vapors are suctioned off in the vapor trap by means of a low negative pressure. After interaction with the beam, the smaller drop lands on the substrate.

FOURTH EMBODIMENT

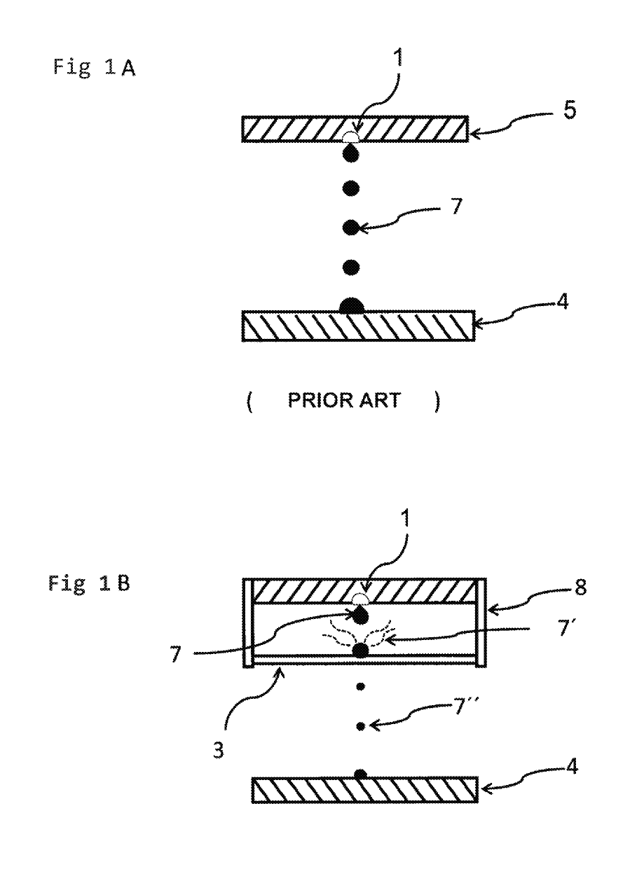

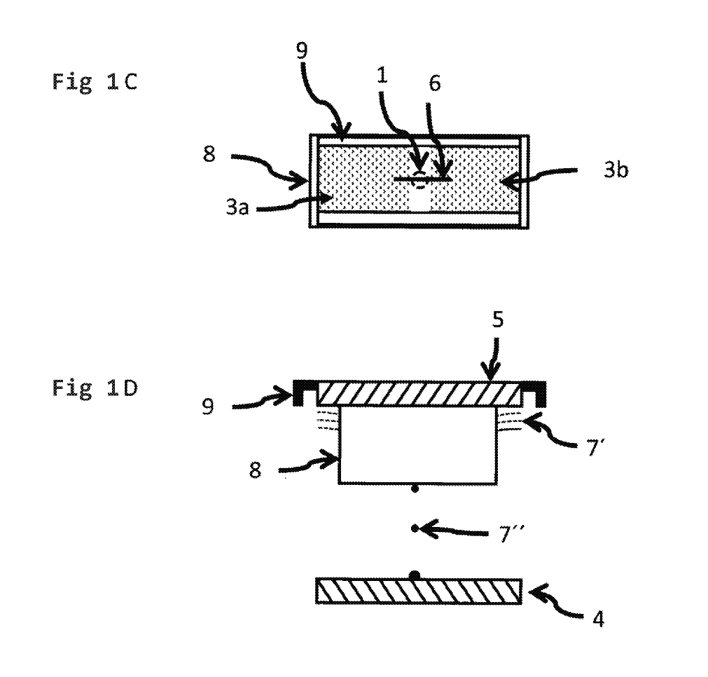

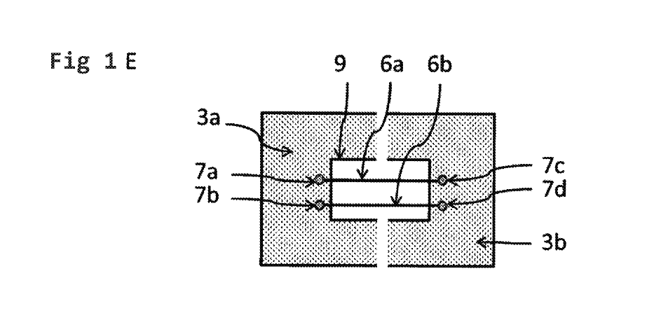

FIG. 1 is a schematic description of an inkjet printhead on which filaments according to the invention for generating a zone with a locally increased temperature are arranged. The drops 7 are generated out of the ink in the printhead 5 by a piezo element and after the discharge thereof from the nozzle 1, reach the substrate 4 without barriers after a flight phase. This procedure is shown as prior art in FIG. 1A.

FIG. 1B is the side view of the inkjet printhead 5 with the attachment 8 for an “in-flight” vaporization of drops 7 by heating of the drops by means of filaments. The generated drops 7 leave the nozzle 1, fly through between the wires, which are fastened between two metal plates. A current is conducted from one metal plate to the other by the two thin wires. The current generates the required joule heating in the wires but not in the metal plates 3, because the surface area thereof is much greater and the electrical resistance thereof is weaker. The heating generates a temperature gradient between the environment around the wires and the remaining space around the printhead. The metal plates are arranged on the heat shield, which is directed towards the printhead. The drops 7 pass the filament or filaments and vaporize. The vapor 7′ is suctioned off via the vapor trap in the attachment 8. As a result, the volume of the drop is reduced and drops 7″ are printed onto the substrate.

FIG. 1C is a schematic view from below of such an inkjet printhead 5 with the attachment 8 for an active “in-flight” vaporization of drops by heating by local vaporization with a filament 6. The two metal plates 3a, 3b are shown. The metal plates are arranged on the heat shield and in the manner of these components of the attachment for the printhead, which is not shown due to the view from below. The metal plates are self-evidently provided with means to apply a current. Therefore, a direct current or an alternating current can be applied to the plates. Said current heats a thin wire 6, which is located underneath the nozzle 1. Two horizontal slots 9 are provided in the attachment as a vapor trap for the vaporized solvent 7′. There is a slight negative pressure at the vapor trap 8, which suctions the vapor 7′ out of the critical zone between the printhead and substrate.

FIG. 1D is a side view, rotated by 90° in comparison with FIG. 1B. The attachment 8 is arranged on the printhead 5. The vapor trap 9 is achieved as a circumferential channel, which is arranged in the edge region of the attachment 8. The solvent vapors are suctioned off into the vapor trap by a small negative pressure. After the interaction with the wires, the drop 7″ with a smaller volume lands on the substrate 4.

FIG. 1E is a schematic view from below of the second part of the attachment 8 for an “in-flight” vaporization of drops with heating by local vaporization alternatively with two wires 6a, 6b. The second part of the attachment comprises the two metal plates 3a and 3b, which are electrically interconnected by the two thin wires 6a, 6b. Two silver points each, 7a and 7c, and 7b and 7d respectively, are provided in this case for fastening the filaments to the metal plates. The metal plates have an intermediate space therebetween such that they are electrically insulated from one another apart from the filaments. A current flows through the two wires 6a and 6b and generates the heating of the wires 6a and 6b and consequently the desired temperature gradient underneath the printhead that is directed towards the substrate and towards the rest of the printhead environment. The generated drops fly out of the printhead nozzle 1 through in between the filaments 6a and 6b and in the process, are partially vaporized by the temperature gradient. After the interaction with the wires, the smaller drop lands on the substrate 4. Reference numeral 9 denotes the opening between the metal plates in which the filaments are stretched.

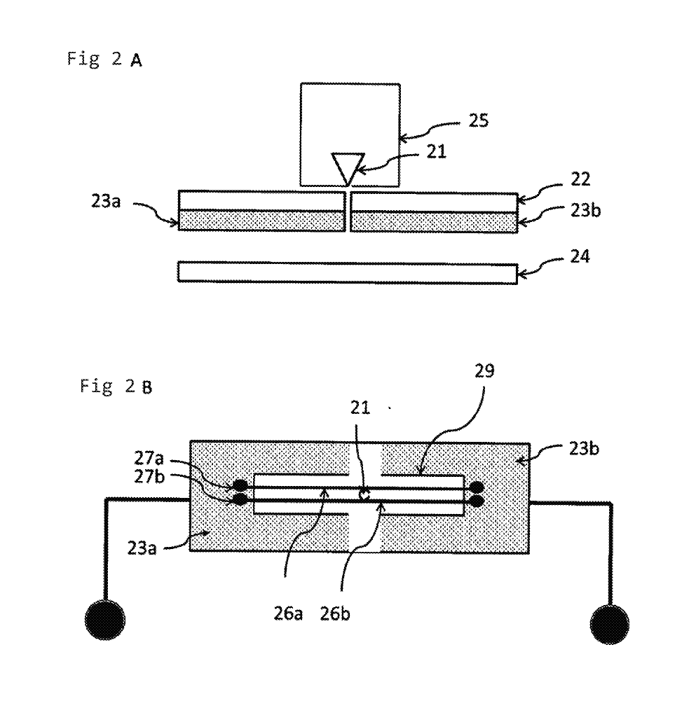

As an expansion of FIG. 1, the upper part A of FIG. 2 is a cross section of an assembly and attachment according to the invention for carrying out the method. The assembly is cut through at the location of the nozzle 21 of the printhead 25 and shows the alignment thereof above the openings in the heat shield 22 and the metal plates 23a, 23b. In this case, the attachment according to the invention comprises the heat shield and the two metal plates 23a, 23b. The surface of the heat shield 22 consists of non-conductive anodized aluminum and has the dimensions W×H×D of 100×0.5×20 mm. Two metal plates arranged underneath are electrically insulated from one another (see FIG. 2B) and have the reference numerals 23a and 23b. The metal plates 23a and 23b consist of steel. They each have dimensions of 45×0.5×20 mm (W×H×D). The total height of the heat shield 22 and metal plates 23 accordingly amounts advantageously to only about 1 mm. The two plates 23a and 23b are provided with supply lines for applying an electric current. This is shown in Figure B in the lower part of FIG. 2. The two filaments 26a, 26b each have a diameter of 25 to 80 μm and a length of about 5 mm, since the opening has corresponding dimensions. The wires are fastened to the metal plates 23a and 23b by two silver adhesive drops 27a, 27b in each case. Only the silver adhesive drops on the left-hand metal plate are provided with reference numerals, apart from this, however, the assembly corresponds to that in FIG. 1E.

This attachment according to the invention of the heat shield 22 and metal plates 23 plus the filament or filaments and electrical supply lines is baked at about 150° C. for about ½ an hour to rigidly fasten the filaments. Afterwards, the two wires 26a, 26b have a gap therebetween of between 50 to 200 micrometers, depending on the positioning of said wires relative to one another. The attachment is preferably introduced into an existing printhead system with one or more nozzles using magnets sunk into the printhead. The metal steel plates are aligned with the substrate to fasten the attachment to the printhead 25, and the heat shield accordingly with the printhead. The attachment is arranged in a particularly simple manner due to the magnets sunk into the material of the printhead. Said magnets fasten the attachment to the printhead such that it can still be adjusted.

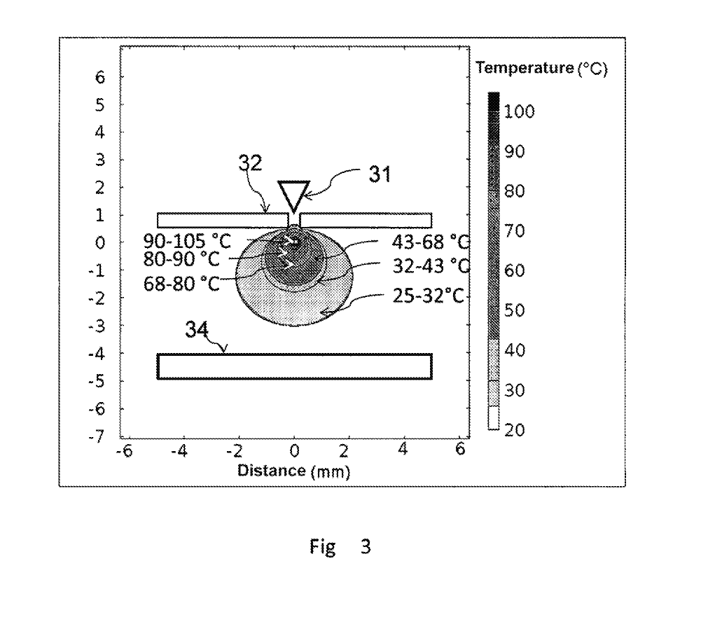

FIG. 3 shows a temperature profile generated according to the invention, which was simulated using the Comsol program (Comsol Inc., USA). In the 2D simulation (cross section), two copper wires with a diameter of 25 μm are arranged next to one another with a gap of 100 μm. 500 μm away from the wires, a heat shield 32 made of aluminum is arranged with an opening underneath the nozzle. The opening has a length of 500 μm. The heat shield has a thickness of likewise about 500 μm. Current with the strength of 150 mA is conducted through the wires in order to generate the joule heating of the filaments. The ambient temperature is set to 20° C., and the temperature gradient generated by the joule heating is recorded with various black and white shadings on FIG. 3 as a 2D temperature profile.

The heat shield 32 and the nozzle 31 are shown schematically. These and the substrate are left out from the local temperature increase, as the simulation shows. It becomes clear that by means of the assembly according to the invention of the printhead and heat shield, as stated, the method according to the invention can be carried out, and the zone with a locally increased temperature in various temperature regions can be generated and sub-divided. The temperature gradient shown in FIG. 3 therefore has by way of example, regions of different temperatures. These are between about 25° C. at the edge region and about 105° C. directly on the filaments and are generated by the two filaments used for the simulation at a current strength of 150 mA. In this case, the temperature gradient is indicated on a free path length of about 3 mm. On the free path length of the y axis from 0 mm (positioning of the filaments) up to about 0.5 mm, in the present case, temperature differences from about 68-105° C. are achieved, which results in a temperature difference of nearly 40° C. On the path length of the y axis between 0 mm and 1 mm, temperature differences of even about 80° C. are achieved. In this case, the temperature profile, due to a heat shield 32, is of the asymmetrical type, which means that the printhead is in the cool, whereas the drop passes through the hot zone and falls onto the cold substrate.

With such an assembly according to the invention and the attachment according to the invention, as shown in FIG. 1B-1E and in FIG. 2, it is accordingly possible to locally heat an ink drop directed through the openings in the heat shield and plates and to reach a reduction in volume of the drop that comprises at least 10% of the original volume. It is self-evident that this simulation is given by way of example. It is possible to generate other temperature gradients within the scope of the invention. For this purpose, a person skilled in the art will adapt the material of the filaments, plates, and heat shield to the conditions at the printhead and achieve the required reduction in volume of the drop. Furthermore, it is self-evident that a person skilled in the art can select and combine materials freely with one another. For example, it is possible to combine the materials as follows.

### EMBODIMENTS 5 TO 9

For example, glass with an opening of 0.5 mm can be used as a heat shield. Two steel plates having a thickness of 0.5 mm are bonded directly onto said glass. The filament is bonded to the steel plates as described with conductive silver adhesive and baked.

For example, glass with an opening of 0.5 mm can be used as a heat shield. Two carbon plates having a thickness of 0.1 mm are bonded directly onto said glass. The filament is bonded to the carbon plates with conductive carbon paste.

For example, ceramic with an opening of 0.5 mm can be used as a heat shield. Copper plates having a thickness of for example, 0.1 mm are bonded onto said ceramic. The filament is bonded to the copper plates with conductive silver adhesive.

A person skilled in the art can use lithographic methods in order to process the attachment.

For example, glass or quartz can also be processed as a heat shield with the method of optical lithography. The glass or quartz is used as a heat shield and has an opening of 0.5 mm. Two ITO (indium tin oxide) plates are deposited thereon with a thickness of 1 μm and structured with optical lithography. Between the plates, the filament or a mesh of tungsten which has a width of 10 μm is deposited on the glass or quartz and between the ITO plates and structured with optical lithography in such a way that the two ITO plates are bridged with the tungsten wires.

A person skilled in the art can use further deposit methods from optical lithography in order to produce an attachment according to the invention.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. An inkjet printing method, comprising:
directing a printhead of an inkjet printer towards a substrate to be printed;
generating ink drops in the printhead of the inkjet printer and discharging the ink drops from a nozzle of the printhead; and then
directing the ink drops into a zone with a locally increased temperature so as to actively reduce a volume of the ink drops during a phase of flight to the substrate.

2. The inkjet printing method according to claim 1, wherein a reduction in the volume of the ink drops by at least 10% occurs.

3. The inkjet printing method according to claim 1, wherein a reduction in the volume of the ink drops by at least 20% or up to 99.99% occurs.

4. The inkjet printing method according to claim 1, wherein the zone of locally increased temperature is generated by at least one filament or by at least one light source.

5. The inkjet printing method according to claim 1, wherein the zone of locally increased temperature is generated by an arrangement of at least two filaments, between which the ink drops are directed.

6. The inkjet printing method according to claim 1, wherein the zone of locally increased temperature has a temperature difference of at least 10° C. over a 1 mm path length.

7. The inkjet printing method according to claim 1, wherein printhead is protected from the zone of locally increased temperature by a passively or actively cooled heat shield.

8. An assembly comprising:
an inkjet printhead having a nozzle; and
at least one filament configured to have an electrical current applied thereto, or a light source between the nozzle of the inkjet printhead and a substrate to be printed, configured to generate a zone with a locally increased temperature and heating of ink leaving the printhead nozzle.

9. The assembly according to claim 8, comprising at least two filaments, between which the ink is directed towards a substrate.

10. The assembly according to claim 9, wherein the ends of at least one of the two filaments are fastened to two plates which are electrically insulated from one another.

11. The assembly according to claim 10, wherein the two plates are arranged directly on a passively or actively cooled heat shield, which is directed towards the printhead.

12. The assembly according to claim 8, wherein the filament or filaments or the light source can generate a zone of increased temperature between the printhead and the substrate which zone has a temperature profile having a temperature difference of at least 10° C. over a path length of 1 mm.

13. An attachment for a printhead of an inkjet printer, comprising
a heat shield having an opening,
first and second plates arranged directly on the heat shield, the plates being directed towards a substrate and provided with electrical supply lines, the plates being separated from one another by an intermediate space, the intermediate space being arranged underneath an opening of the heat shield, and
at least one filament configured to connect the plates to one another,
wherein the electrical supply lines are configured to conduct current via the plates into the at least one filament so as to generate a zone with a locally increased temperature.

14. A printhead comprising a fastener configured to fasten an attachment according to claim 13.
